(19) United States
(12) Patent Application Publication
(10) Pub. No.: US 2009/0183710 A1
(43) Pub. Date: Jul. 23, 2009

(54) HEAT ENGINE

(75) Inventor: Bernard Philberth, Victoria (AU)

Correspondence Address: GANZ LAW, P.C., P O BOX 2200, HILLSBORO, OR, 97123, US

(73) Assignee: Alfons Lemm, Floreat, WA (AU)

(21) Appl. No.: 11/996,954

(22) PCT Filed: Jul. 20, 2006
(86) PCT No.: PCT/IB06/01997

§ 371 Date: Jun. 20, 2008

(30) Foreign Application Priority Data
Jul. 26, 2005 (CH) 01244/05
Nov. 30, 2005 (CH) 01899/05

(51) Int. Cl. F02B 19/00; F02B 19/10; F02B 19/02

(52) U.S. Cl. 123/268; 123/274; 123/292

(57) ABSTRACT

The Process Chamber Motor PKM is a combustion piston engine comprising a Process Chamber as a novel type of prechamber, into which fluid fuel continually flows and is processed therein over a plurality of cycles to form a PKM-combustible-material.

Above the Compression Chamber—separated by an impermeable Separating Wall—lies a Process Chamber PK, into which fuel is pushed over a long period (gear pump), therein vaporizing and therein being processed with added oxygen-overstoichiometric gas to form combustible material: gas, possibly with smoke and soot. The PK contains combustible material for at least two cycles, sustained at a pressure near the maximum attained above the piston and sustained at Process-temperature (e.g. 800° C.). The portion of combustible material to be combusted in the respective cycle streams—via a valve (e.g. pneumatically-actuated Cylinder-Valve) which is opened in the culmination zone—into the Combustion Chamber.

The Process Chamber is enclosed by a Pressure Wall, with an inlaid Pore Wall with pores through which an oxygen-overstoichiometric Pore-Stream streams into the interior of the Process Chamber (containment of pressure without heat and containment of heat without pressure). Additionally: two-stage pump systems for fuel and/or lubrication; Peltier-current-controlled startup-igniter with temperature controller.

The Process Chamber Motor PKM is in its concept difficult, but its implementation and operation is problem-free and extremely simple.

The PKM from Philberth is a piston engine with a Process Chamber PK. The PK is separated from the Compression Chamber PR, which is the space above the piston enclosed by the Cylinder Wall ZW, by a compact Separating Wall TW in which a valve Ve is embedded. While the Ve is open, the PR is the Combustion Chamber BR, and streaming via the Ve is the Transit-Stream PK/BR (gas from PK into BR or BR into PK). Above the valve the PK is enclosed by the Heat Wall WW, as a porous Pore Wall PW. The WW is enclosed by the Pressure Wall DW which holds the pressure. Multi-cylinder engines (e.g. 3, 5, 7, . . . cylinders) advantageously have a common PK and WW.

The fuel flows as Fuel-Flux K-Flux into the PK, where it is processed to Process Chamber Gas PK-Gas; with overstoichiometric gas, which streams into the PK. This is less-overstoichiometric BR-Gas from the BR and/or more-overstoichiometric Process Gas PC-Gas. Typically the PC-Gas is taken off from the BR; via an offtake-volume Vₐ.

The PC-Gas streams into the PK as Pore-Stream and possibly as Adding-Stream.

The Adding-Stream A-Stream is fed into the K-Flux in the PK-feedline.

The Pore-Stream P-Stream is specifically Wall-Stream W-Stream through the WW.

The Pore-Stream of the PKM prevents KTH, the deposition of coke/tar/resin.
The P-Stream—from the pores into the PK—oxidizes smoke and gaseous soot near the WW.

The PK-Gas (the PKM combustible material) combusts in the BR while the Ve is open; via Transit-Stream PK→BR: in the Fore-Shot before, & in the After-Push after the culmination. In between there is possibly the Return-Push, in which the piston pushes BR-Gas into the PK.
In the case of a piston-lifted valve: there is possibly a Gap-Stream S-Stream as PC-Gas through the Ve-gap; there is possibly a Stem-Stream H-Stream as PC-Gas via the Ve-stem into the BR; there is possibly a Head-Stream K-Stream through the Head Wall (porous wall, on the PK-side of the Ve).
The S- & the H- & the K-Stream are fed to the Ve as Valve-Stream V-Stream.
Only the H-Stream is PC-Gas that recirculates. All other PC-Gas processes.

| | | |
|---|---|---|
| Positions Pₙ of the piston crown: | Upwards | P₀-P₁-P_{H}-P₂-P_{G}-P₃ |
| P₃ highest (culmination) | Downwards | P₃-P₄-P₅-P₆ (P₆→P₀). |
| P_{xz} from position Pₓ to P_{z}. | Phases P_{zx} | from P_{z} to Pₓ (via P₆ = P₀). |

| | | | |
|---|---|---|---|
| Phases P₁₂ compression; | P₂₄ burning; | P₄₅ expansion; | P₅₁ changeover. |

| | | | | |
|---|---|---|---|---|
| Temperature | T_{K} in the PK; | T_{R} in the PR; | Tₙ at Pₙ; | T_{xz} in P_{xz} |
| Pressure | p_{K} in the PK; | p_{R} in the PR; | pₙ at Pₙ; | p_{xz} in P_{xz} |

| | | | |
|---|---|---|---|
| Volume | V_{K} of the PK; | V_{xz} between Pₓ & P_{z}; | V_{xT} between Pₓ & TW |

PKM-Characteristics and -Operation. Concrete Implementations & Suggestions:
Whichever atoms enter the system must also exit; only molecularly restructured (possibly integrating over several cycles). Consequently all operating states in the PK (incl. the T_{K}) are set up perforce with the specified lambda: appropriate for the function & material, with non-critical PK-lambda. The PKM has few adjustment-problems: very simple.
The PKM operates perfectly with every fuel (irrespective of octane & cetane number). K-Flux can be fed into the PK in any fashion: advantageously continually via gear pump.
Although the PK may be classified as a “prechamber”, it is intrinsically different to the conventional prechambers. The PK contains combustible material—fuel that is fully processed to PK-Gas—for considerably more than one cycle (e.g. 5 to 50). The PK interior is at sustained high pressure & high temperature (e.g. 170<p_{K}/bar<250; 400<T_{K}/° C.<1200): constant, with slight fluctuations.
The overstoichiometric processing gas is PC-Gas and possibly Return-Push. The PC-Gas may be established in any way (for instance from V_{3T} via offtake Vₐ with a check valve).
The PK-Gas (the PKM combustible material) can contain vapour, smoke, gaseous soot; is continually generated in the PK-Process; and is consumed stepwise via valve-openings.
Via the opened valve Ve, PK-Gas comes into the BR-Gas for combustion. As each is above autoignition temperature, PK-Gas reacts with BR-Gas without delay, without external ignition; there is never any flame front, sonic boom or shock-detonation. Reaction is always smooth & complete: regardless of the amount of exhaust gas in the supply gas (e.g. with 99% as with 0%). Therefore the problem of scavenging does not exist for the PKM. The PKM as a two-stroke with 50% exhaust gas recirculation (EGR) is as effective as a four-stroke without EGR. Via conventional exhaust and inlet valves the PKM could be a four-stroke.
The PKM is advantageous as a two-stroke: changeover (exhaust-removal & air-intake) via ZW-ports which are exposed in P₅₁. Alignment of exhaust ports perpendicular to & intake ports near-parallel to the ZW is advantageous. As of P₁: intake air+exhaust gas=supply gas.
The PKM-two-stroke requires only a single valve Ve. When opened it has Transit flow resistance TSw to the Transit-Stream. With small TSw only a small pressure difference remains at the end of the Transit: equalisation of the BR-pressure p_{R} with the PK-pressure p_{K} which fluctuates little (in practice persistently constant at say 200 bar; results in smooth operation).
The opening of the valve Ve occurs in the piston culmination zone (e.g. shortly before P₃ until somewhat after P₃). The time-function of the opening is non-critical, no timing-problems.
The PKM works with valve-opening by every method; e.g. (I) Lifting by the piston, which has been freely chosen as the basis for the present PKM-description (Spring-Valve). (II) Lifting via piezo- or magneto-hydraulic actuation on the valve-base (beneath which a TW provides separation from the PR), but also valve-opening via slotted-shaft or slider.
   (III) Valve-opening from the outside; e.g. cam-actuated. Good prospects with pneumatics, e.g. realised via piezo- or magneto-electric actuation (Cylinder-Valve).

### Comparisons Conventional Combustion Engines for Over a Century:

| | | |
|---|---|---|
| OtM | “Otto Motor” | homogeneous air-fuel mixture is spark-ignited. |
| DsM | “Diesel Motor” | injected fuel ignites in compressed air. |

The OtM ignites locally whilst the DsM injects cold fuel: the combustion process that should take place in ˜1 ms must traverse the combustible substance by ongoing ignition. This requires perfect scavenging. Hence the OtM and DsM are mostly four-strokes.

The OtM; conceptualised in the 19^{th} century by Otto & Langen as a “town gas” engine: as a transportable source of gas with “gasification” of volatile petroleum components which Benz successfully eliminated (mole aliphatic “Benzin”, aromatic “Benzol”).

The OtM compresses a homogeneous air/fuel mixture and ignites this shortly after the culmination with an ignition-spark: the optimal timing of ignition is difficult to achieve. More highly effective compression ratios require addition of lead alkyls or aromatics to help prevent “knocking” (compression ignition before the culmination): problematic.

Despite sophisticated electronics, a satisfactory solution has not yet been found to always achieve the optimal gas-ratio (weakly overstoichiometric).

Only a small fraction of hydrocarbons within petroleum (specific molecules) is usable.

The OtM is occasionally (e.g. in light motorcycles or automobiles) used as a two-stroke. However, the OtM-two-stroke always suffers from loss of fresh mixture.

The DsM; conceptualised in the 19^{th} century by Diesel: It compresses air to such a high temperature, that liquid fuel (“diesel”) injected after the culmination ignites.
The cold diesel oil must first heat up, vaporise, mix, crack & then ignite from local ignition points. This chain of events is delayed and does not take place to completion everywhere. Oil which adheres to the walls remains too cool to ignite. Heavy oil molecules diffuse too slowly from the wall into the hot, turbulent combustion region. The degree of mixing remains unsatisfactory, such that CO & H₂ are formed in some parts of the cylinder, beside NₓO_{z} & O₃ in other parts; all remaining during the expansion and cooling process.

A greater excess of air cannot significantly reduce the long reaction chain & cannot accelerate the diffusion from the walls; it reduces the operating temperature and thereby the effectiveness. In addition, ozone and nitrous oxides are formed along with dioxins, benzopyrenes & many kinds of toxins. Soot which is also formed further activates these.

The DsM combusts incompletely & uncleanly; with environmentally damaging exhaust:

The DsM has been subjected to extensive and effective development. Direct Injection with up to 2500 bar delivers a sharp burst against the compression pressure leading to a fine fuel spray. The injection must be defined under all circumstances, even for variable viscosity. There have been variants in which fuel was injected against the wall or a hot-bulb; more recently, piezo inline injectors have proven to be effective.

Special variants include sharp fuel bursts with a swirl chamber or prechamber.

The prechamber is part of the combustion chamber into which the liquid fuel is injected. Air pushed into the prechamber by the piston partially pre-combusts the fuel to form a combustible substance, which streams through mesh-like openings for final combustion in the other part of the combustion chamber: short duration reaction following the Diesel principle.

The DsM fuel consumption and pollutant emissions are still too high. Only a small fraction of hydrocarbons within the petroleum (with specific molecules) is suitable for use in a DsM.

The DsM occasionally (mostly for slow, large engines) operates as a two-stroke. In this case more time is required for combustion. DsM two-strokes with a portion of exhaust gas in their supply gas would have more favourable power output and operating temperatures than four-strokes. However in a DsM this would lead to sluggish ignition and slow combustion.

Fundamentally (small TSw) The PKM is perfect in all three performance criteria:
I. The homogeneity of the intermixing of combustion components;
II. The approximation to stoichiometric combustion (to CO₂, H₂O, N₂);
III. The completeness of fuel-combustion up to the commencement of expansion.
1. P_{2G} Fore-Shot Strongest exothermic reaction: hot, understoichiometric PK-Gas streams above the piston and combusts in the supply gas (in the BR); each with temperatures above autoignition temperature. Residuals of liquid fuel are vaporised at the valve. In the Fore-Shot: ideal combustion of most of the substance.
2. P_{G3} Return-Push Exothermic reaction in the PK: The piston pushes partially combusted overstoichiometric BR-Gas into the PK, which reacts with the understoichiometric PK-Gas. In P_{G3} the PK-temperature rises. The PK-pressure p_{K} self-adjusts to almost a constant value p₃. Without Return-Push, PK-overpressure is set up (p_{K}>p₃)
3. P₃₄ After-Push: Understoichiometric PK-Gas pushes above the piston (fuel flowing in during P₃₄ vaporises). The exothermic reaction raises the temperature.
4. P₂₄: The combustion is perfect because it occurs over the full duration of P₂₄. Although non-critical, it is good if combustion occurs more towards the end of P₂₄ (performance & temperature): combustion is always accurately constrained by the specified lambda.
5. P₄₂: The fuel continually reacts in understoichiometric conditions in the PK-Gas. If there is any Return-Push, the PK-lambda and PK-temperature drop slightly. Fuel inflow & Pore-Stream affect the T_{K} and p_{K}; but the final lambda necessarily remains unchanged.
6. Specification of the optimal oxygen/fuel ratio (lambda) is practically no problem.
7. No ignition required (except possibly for startup). Octane and cetane numbers are irrelevant.
   Note: The point of first contact between piston and valve, P_{H}, is at the same height as P₄. With inelastic valve-lift, P₂ is at the same height as P₄. With elastic valve-lift P₂ is higher than P₄.
   V_{1T}/V_{2T} compression ratio: due to the PK-volume only effective after several cycles.
   V_{G3}/V_{GT} Return-Push: volume reduction by which BR-Gas is pushed into the PK (proportionately less gas than volume, due to increase of PK-temperature T_{K}).
   Not critical, broad range: small amounts of Return-Push yield a low PK-lambda; large amounts of Return-Push yield a high lambda, with high T_{K} (adjustable, as required).

| | | |
|---|---|---|
| Concrete Example | Inelastic Valve Lift | Illustrative example only: |

| | | | |
|---|---|---|---|
| Cycle angle βₙ | At the start of the cycle - at P₀: | β₀ = 0° | then e.g.: |

| | | | | | |
|---|---|---|---|---|---|
| β₁ = 30°; | β₂ = 160°; | β₃ = 180°; | β₄ = 200; | β₅ = 330°; | β₆ = 360°. |

| Phase angle β_{xz} = β_{z} - βₓ | Angle turned through in P_{xz} (from Pₓ to P_{z}), for instance: | | |
|---|---|---|---|
| P₁₂ compression | β₁₂ = 130°; | P₂₄ burning | β₂₃ = β₃₄ = 20° |
| P₄₅ expansion | β₄₅ = 130°; | P₅₁ changeover | β₅₆ = β₀₁ = 30° |

| Swept Volume = | V₀₃ ÷ 132.9 mm: gives ⅛-litre with 941 mm² piston crown area | |
|---|---|---|
| Given: | V_{2T} ÷ 8 mm & V_{1T}/V_{2T} = 16 (compression ratio). | V_{1T} ÷ 128 mm |

| | |
|---|---|
| Crank radius Rₕ = 66.45 mm; | compression height V₁₃ ÷ Rₕ (1 + cosβ₀₁) = 124 mm |

| | |
|---|---|
| Valve-lift V₂₃ ÷ Rₕ (1 − cosβ₂₃) = 4 mm; | residual volume V_{3T} ÷ 4 mm |

(÷ means: equal to the length which corresponds to the volume in question)
V_{K} & T_{K} affects the effective compression ratio; connecting rod length affects V₁₃ & V₂₃

| | | | |
|---|---|---|---|
| Tolerances for β_{2G}: | 0°; P₂ = P_{G} | 10° P_{G-concrete} | 20°; P_{G} = P₃ |
| V_{G3} & Return-Push: | 4 mm & 50% | 1 mm & 20% | 0 mm & 0% |

If P_{G} approaches P₃, then the Return-Push becomes small or even zero.

This is to be compensated with proportionately greater Pore-Stream and/or Adding-Stream.

Variant with Elastic Valve Lift: The valve-stem or piston contact area is sprung with an elastic force (spring constant): so weak, that the piston does not yet lift the valve at first contact (p_{K} much higher than p_{R}), but does lift it before P₃ (e.g. β₂=170°); so strong, that the valve which is lifted by the piston+elastic force only shuts at P₄ (e.g. β₄=200°). The point at which the valve starts lifting is defined, for instance when the spiral- or disc-spring is fully compressed at P₂; advantageous full compression of spirals or discs to form a stable cylinder.

Standard Units (Although personally active in the standardisation of units): As heat is such a peculiar form of energy, its Joule-standardisation is practically “unthermodynamic”. Heat as diffusive molecular energy is best expressed in “cal” & “kcal”.

Heat Q: The exact conversion accurate to 4 ppm is: 1 Ws (Joule)=0.239 cal Precisely: gas-constant 2 cal; specific heat for gas at constant volume 1 cal/F_{V} (F_{V} as translatory & rotatory degrees of freedom); molar heat 6 cal/mol As a result (for ideal gases) the temperature increase ΔT [° C.] is very precisely [cal/F_{V}]

Valve Ve The valve-body is fitted movably in the valve-guide in the TW. It is advantageous that the valve has a cylindrical valve-stem with a conical head above. It is advantageous if the TW has openings TO in the valve-guide, near and above the valve-cone shoulder. Contact pressure of the valve closes the openings, with the cone of the Ve-head. Lifting of the valve exposes the openings, as a conical gap is opened up above the Ve-guide: in the Fore-Shot PK-Gas shoots into the BR-Gas whilst in the After-Push PK-Gas pushes into the BR-Gas; in the Return-Push BR-Gas pushes into the PK-Gas. The rapid Fore-Shot and overstoichiometric Return-Push do not cause any deposition.

The valve-stem slides in the Ve-guide at approximately TW-temperature. In the After-Push fuel blows through the gap and lubricates the sliding surfaces. A K-Stream and/or H-Stream—for instance introduced as V-Stream via a ring groove in the cylindrical Ve-guide—results in especially low Ve-temperature; but is presumably unnecessary (not a problem in the future).

The Fore-Shot is initiated by a pressure differential of approx. 3 times the compression pressure. It first increases parabolically and then (as PR approaches p_{K}) tapers off smoothly, whereby the TSw becomes small: The transition into the Return-Push begins.

With external control of the valve-lift or with a spring valve, position P₂ can be moved closer to P₃ (e.g. 10° to 5°) than P₄ (e.g. 10° to 20°): Fore-Shot from shortly before P₃, which begins smoothly, reaches a maximum at say P₃, & (without Return-Push) transitions into the After. Push up to P₄. Thus a moderate combustion is readily achievable, nearer to and after the culmination. The PK-pressure p_{K} necessarily self-adjusts to any time-function of the valve-lift, and hence the exact implementation of this function is non-critical.

Tiny slanted grooves at the valve-edge cause slight rotation of the valve.

Process Chamber PK The PK-volume V_{K} acts in relation to the swept-volume: V_{K}/V₀₃.

Proportional to V_{K}/V₀₃ is the average process duration Dp of the fuel in the PK.

Proportional to V_{K}/V₀₃ is—after a change in power output—the setup duration Ds to attain stationary operation (reciprocal-exponential approximation; e.g. after 3Ds to within ˜ 1/20).

PKM-specific is the “Cycle Number” Zz: for how many cycles the PK stores K-Flux (fuel/cycle) as PK-Gas; Zz depends on the PK-lambda.

Examples, each for lambda 1 during operation & for lambda ½ in the PK, with fuel [HCH]
For only intake air in the supply gas: 8 mol PK-Gas per 15 mol supply gas (factor 8/15). With compression to p_{K}=200 bar (factor 1/200) and temperature T_{K}=800° C. (with factor 3.75 of the absolute-temperature-ratio): V_{K}/V₀₃=0.010 Zz.
For recirculation with 50% exhaust gas in the supply gas: V_{K}/V₀₃=0.008 Zz.

Roughly: 100×V_{K}=Zz×V₀₃. With Zz=25, we have V_{K}=¼V₀₃; with 50 cycles/s,

we have Ds=½ s, with process duration Dp approx. 200 times longer than with Diesel-injection. Fluctuation ΔT_{K}<5%, Δp_{K}<4%. Even in the Return-Push PK-Gas does not penetrate (against the overstoichiometric Pore-Stream) into the PW: no deposition is possible.
Startup-Work This is reduced with a larger PK because the first compression stroke only requires a compression ratio of V_{1T}(V_{2T}+V_{K}) (compression-pressure lifts the valve). If ignition occurs at this point, possibly via startup-ignition system, the first, light compression strokes take over the startup work. The latter is so small that the alternator may be able to achieve startup. Particularly advantageous for multi-cylinder engines:
Multiple Cylinders A shared PK requires only a slightly larger PK than a single-cylinder: fewer cycles are needed to reach stationary operation (only a single startup-ignitor). Shared: channel space, feed line, pumps. However V_{3T} offtake occurs via check valve (non-return valves, taps) from each cylinder. Advantageously offtake lines lie inside the supply line for counterflow heat exchange (heat-transfer: cold pump & high gas density).

### PK-Lambda

The PKM works with fuel of any viscosity and density. Pore-Stream and Return-Push affect the PK-lambda and thereby the PK-temperature T_{K}. The Return-Push varies with twice the angle β_{G3} (the function 1-cos is approximately quadratic). Corresponding heights for V_{G3} & V_{3T} (in concrete terms 1 & 4 mm) are not a significant problem.

Petrol and diesel fuel vaporise completely inside the PK; viscous heavy oil vaporises mostly.

All processes are governed via the F_{V} of the molar heats of formation

CO₂ 94.4 kcal; CO 26.4 kcal; H₂O (gas) 57.8 kcal; HOCN 36.6 kcal; CH₄ 19.1 kcal.

| Regularly fuel [HCH] approx. 8 kcal. | Endothermic: HCN −30.1 kcal; C₂H₄ −9.6 kcal. | |
|---|---|---|
| All as ideal gas at 200 bar/800° C. | | PK-gas-density 50 to 65 g/L |
| Lambda with air (O₂ + 4N₂) | Heat Q/Fᵥ [cal/Fᵥ] | fuel/PK-Gas [gfuel/L] |

| Lambda | Most energetic reaction in each case | with heat | cal/Fᵥ | gfuel/L |
|---|---|---|---|---|
| 1 | 1½O₂ + [HCH] → CO₂ + H₂O (6N₂) | +144.2 kcal | 3510 | 4 |
| 0 | 2[HCH] → CH₄ + C | +3.1 kcal | 280 | 63 |
| ⅓ | O₂ + 2[HCH] → CO₂ + 1CH₄(4N₂) | +97.5 kcal | 3140 | 10 |
| ⅙ | O₂ + 4[HCH] → CO₂ + 2CH₄ + 1C (4N₂) | +100.6 kcal | 2340 | 18 |
| 1/12 | O₂ + 8[HCH] → CO₂ + 4CH₄ + 3C (4N₂) | +106.8 kcal | 1590 | 28 |
| 1/24 | O₂ + 16[HCH] → CO₂ + 8CH₄ + 7C (4N₂) | +119.2 kcal | 1030 | 39 |

Maximum Q/F_{V} [cal/F_{V}] however realises a lower temperature increase ΔT_{K} [° C.]<Q/Fv [cal/F_{V}]: because amongst other things endothermic associations and disassociations take place: CO₂+CH₄+N₂→2HOCN+H₂; CH₄+C+N₂→2HCN+H₂; CH₄+C→C₂H₄. CO₂+CH₄→2CO+2H₂; CH₄→C+2H₂; CO₂+C→2CO; CO₂+H₂→CO+H₂O. Lower temperature forces more energetic reactions: prevents temperatures becoming too low. High temperature forces more endothermic reactions and activates oscillatory degrees of freedom: prevents over-heating. This “Principle of Least Constraint” results in stable self-adjustment of temperatures suited to the PKM.

Exhaust gas recirculation does not itself alter lambda. However, it does re-introduce CO₂ & H₂O to the PK, which causes the reactions to shift; mostly towards reduced formation of soot and CH₄. Increasing pressure causes a shift towards fewer molecules. High temperature causes a shift towards lower-energy reactions, which limits the temperature. The PK-temperature T_{K} is almost freely adjustable: the PKM can be more freely and flexibly designed than the DsM.

Petroleum can hardly be gasified in understoichio metric conditions. Amongst other things resistant smoke and gaseous-soot is formed. As individual C-atoms are highly endothermic carbon is formed almost only as a microcluster in understoichiometric, mostly medium-hot gas. Thermal cracking of long chains liberates carbon. H₂ & CO reacts with long chains inter alia under liberation of carbon. The formation of smoke & soot normally leads to progressive deposition of KTH. This is the great challenge.

During the average residence time of several cycles, only gas-like smoke & soot (as found in the glowing flame of a candle) is ever formed inside the PK and is burnt just like PK-Gas, Against the Pore-Stream no deposition occurs in the PK. Every trace of deposition on the Pore Wall is instantly incinerated by the Pore-Stream (as in the outer edge of a candle flame). A very small P-Stream (<1% of the PC-Gas) prevents KTH and penetration of PK-Gas into PW-layers which are too cold.

Only on the PK-side of the valve is deposition possibly to be prevented: e.g. the over-stoichiometric Return-Push can be directed and/or the Pore-Stream can be blown onto the valve, such that it instantly burns any deposit on the Ve-surface.
Or: advantageously the PK-side of the Ve-head can be constructed as a Pore Wall.

This Head Wall KW is permeated by the K-Stream, as part of the Valve-Stream.
And: advantageously the V-Stream also streams via the valve-stem: as H-Stream into the clearance where the Ve-stem slides, and—during valve-lift—into the lower valve-stem and the spring (against penetration of PK- & BR-Gas into the valve-stem).
   Possibly useful is an S-Stream: as PC-Gas via the valve-gap into the PK.

The K-, H- and S-Stream are parts of the Valve-Stream. This V-Stream is PC-Gas that is delivered by the P-Pump or a separate Valve-Stream-Pump (V-Pump). It is fed into the valve for instance via a ring-groove in the cylindrical valve-guide.

Advantageously PC-Gas is taken off from V_{3T}. The volume Vₐ of the offtake can be optimised. It is a partial volume of V_{3T}. With Vₐ=V_{f}×p₃/p₂ (V_{f} is the volume being taken in and delivered elsewhere), the PC-Gas is almost exclusively supply gas at maximum density. The optimum may be with Vₐ<V_{f}×p₃/p₂, in case e.g. the Adding-Stream is preferable as a less overstoichiometric PC-Gas (“diluted” with parts of the BR-Gas already burnt in the Fore-Shot). For each cylinder multi-cylinder engines have a separate offtake from V_{3T} with separate non-return valves; with pressure charging (e.g. >0.8 p_{K}) of the inlet cavity of the P-Pump, which delivers the PC-Gas at positive pressure (e.g. 1.2 p_{K}): for P-Stream, and possibly V-Stream and possibly A-Stream.

Specification of Lambda Lambda-specification for the PKM is simple & persistent. Stoichiometric (lambda 1): enough air is added to the fuel to stoichiometrically yield exactly [CO₂, H₂O, N₂]. For fuel mass [HCH] per air volume [at 1 bar and 0° C.]: 82.2 mg/L.

A synchronous pump (revolutions proportional to the crankshaft) enables fixed adjustment of the volume of K-Flux (fuel/cycle). The intake air is adjustable in the changeover P₅₁; e.g. for lambda 1. This requires only the simplest technology.

The K-Flux (fuel-delivery) dosage is advantageously adjusted with a D-Pump; a gear pump delivering isobarically, which is positioned before the F-Pump which pushes the fuel into the PK. The K-Flux dosage may also be adjusted with a flux-throttle (possibly a pump) positioned before or in-parallel-to the F-Pump. PC-Gas as Adding-Stream (A-Stream) into the fuel feedline to the PK is advantageously added to the K-Flux behind the F-Pump. If an air vessel and a gear pump are used, the PC-Gas can be introduced to the F-Pump from the side.

A cam-guided piston pump can be flexibly implemented; e.g: in P₁₄ drawing in from the fuel-tank via a lower slit in the pump cylinder wall and in P₄₁ pushing into the feedline to the PK.

By necessity, the exact amount of substance supplied to the system exits: with the PKM this is integrated over a few cycles (fewer with a smaller PK). Constant lambda is adjustable by always keeping O₂ supply proportional to fuel supply; for more rapid changes in power output preferably with every cycle: non-critical as adjustment occurs within only a few cycles anyway. All operating conditions are forced into effect within a broad range of sustainable states.

Reduction of O₂ supply can be advantageously achieved by recirculating exhaust gas in the supply gas. The PKM has no difficulty with this; in contrast to the DsM: even with exhaust gas constituting half of the supply gas, the PKM is mechanically, acoustically and thermally superior; even if exhaust gas recirculation should be required for thermal relief during operation. For short periods (minutes) the PKM can thereby double its power output. The main argument for the purchase of motor vehicles with oversized engines thus ceases to apply.

To indicate some possible realisations: If a turbocharger on the intake is driven by the outflow of exhaust gas, then a reduction in fuel supply reduces power to the turbocharger supplying fresh air, which increases the proportion of exhaust gas being recirculated.

Oxygen/Fuel Ratio The PKM works with all fluids that can be combusted without residue, insofar as the pump and fuel lines can cope with the viscosity. On a fixed setting any gear pump always delivers a constant volume per cycle.

Fuels with similar oxygen-mass [g] per fuel-volume [mL]: Diesel approx. 2.7; hexane 2.33; octane 2.47; decane 2.55; cetane 2.69; benzene 2.71; toluene 2.71.

The PKM operates equally well with all fuels currently in use; with consistently easy-to-adjust lambda. For cheap PKM-fuel previously unusable combustible substances may be standardised, amongst other things by admixing of compounds containing radicals: such as —OH or ═C═O, or such as —NH₂ or ═C═C═, as the case may be.

Refineries can thereby process practically all extractable or attainable hydrocarbons to a level which achieves optimal lambda with usable viscosity.

Simple refining techniques suffice, because a viscosity which allows pumping is adequate.

Engine-Idling: Fuel-throttling is regulated by the idling engine speed. This regulates to such low temperatures, that a high lambda without pollutant emission is possible.

Engine startup typically transitions into idling operation. If a startup ignition system is used, it should be applied shortly before turning over the engine, with the battery still unburdened.

Controlling Temperature The PK-temperature T_{K} is adjustable—via the Return-Push and/or P-Stream—to the most suitable value; within broad limits of 200° C.<T_{K}<1400° C.

Even with a working stroke in each cycle, the PR-temperatures in the PKM are still more advantageous than in the DsM. Attempts to achieve full efficiency of a piston engine through utilisation of the maximum combustion temperature have to date been unsuccessful. The PKM can recirculate the optimal amount of exhaust gas in its supply gas and thereby make full use of the two-stroke cycle: with higher efficiency than say the DsM. Voids in the TW for cooling; and heat-insulating coatings on the TW & piston, are optional in the PKM.

The PKM offers several improvements using the volume Vₐ (of the possible offtake from V_{3T}): Only shortly after P₄ (gas backflow from Vₐ into the PR) is the full combustion with pre-specified lambda completed. Up to P₄ the full amount of substance is not yet active and conditions are still to some degree understoichiometric: up to P₄ the T_{K} is thus lower, enabling high levels of energy transformation.

### Pressure/Temperature

Generally problematic: high pressure at high temperature.

In the PK there is sustained high pressure p_{K}; possibly with high temperature T_{K}.

### However:

The heat-free Pressure Wall around the Heat Wall holds the PK-pressure p_{K}.
The pressure-free Heat Wall, inside against the Pressure Wall, holds the PK-temperature T_{K}.
   No problem: 500° C.<T_{K}<1100° C., target 800° C. (red heat); also even higher temperatures.

Suitable materials for PW are ceramics; for the valve highly heat-resistant superalloys with Fe, Co, Ni, Cr, W or Nb, stable to 1000° C. Cermets are suitable for extreme conditions.

If there is no gas-stream past the valve-stem, the valve practically remains at TW-temperature.

The thermal conductivity of the Pore Wall PW is so low, that only tenths of a percent of the heat would flow out: The Pore-Stream returns heat to the PK by counter-flow & prevents KTH.

The channels which introduce Pore-Stream to the PW are against or inside the PW:

For low temperature Pore-Stream, the channels can be constructed against the DW;

for high temperature Pore-Stream, part of the PW lies between the channels & the DW.

Stamp-Valve with valve-lift via externally actuated valve-shaft; for instance:

K-Flux fed into the PK at a central height on the valve-shaft lubricates the valve sliding in the DW and prevents slippage-flow out of the PK. With a valve-piston (at the end of the valve-shaft) in a cylinder the valve may be lifted, for instance hydraulically, A brief pressure-reversal at P₄ (after end of lift) is beneficial for securely closing the valve. The slippage-flow results in self-adjustment of the piston for lifting as of closing-position; the space beneath the piston can be filled with fuel for hydraulic lifting of the valve (e.g. piezo- or magneto-electric). Slippage at the valve-piston (fuel+possibly gas) flows through the valve-shaft into the PK (only a branching of the K-Flux). PC-Gas pushed through pores in the valve-shaft into the PK cools the valve.

For stamp-valves, amongst them Cylinder-Valves, the following is beneficial: smooth lifting from shortly before P₃ (e.g. β₂>170°): opening until further after P₃ (e.g. β₄<200°); inevitably with p_{K}>p₃ (e.g. 5 to 50 bar). With high pressure gradients, the Transit-Stream of a few mL in approx. 1 ms requires only slight valve-lift (e.g. <1 mm, possibly ¼ mm).

Cylinder-Valve special design of pneumatically-controlled stamp-valves.

The Cylinder-Valve has a hollow valve-cylinder VZ of cross-sectional area ø_{V}, which terminates at its base with the valve-cone providing a seal in the TW & which slides in the DW. The DW slide is covered by the WW towards the PK and extends downwards to almost lifting-height above the cone-shoulder. At the top the VZ constricts to a narrower upper cylinder AZ of cross-sectional area ø_{A}, which slides in the DW. Above the constriction the DW encloses a Ring-Space RR with cross-sectional area ø_{V}-ø_{A}, containing gas with pressure p_{L}. With pressure p_{A}>p_{K}, A-Stream streams through the AZ into the VZ (towards blowholes near the bottom). Forces on the valve: up p_{R}×ø_{V}; down p_{A}×ø_{A}+p_{L}×(ø_{V}−ø_{A}). If ø_{A}/ø_{V} is sufficiently small (e.g. ⅛), then at position P_{H} there already is p_{R}×ø_{V}>p_{A}×ø_{A}. This causes:

Upon opening of the vent, p_{L} drops due to streaming-out of RR-gas, until the upward-force prevails: the valve lifts & opens; while there is still some residual pressure p_{L} (e.g. >10 bar).

Upon closing of the vent, p_{L} rises due to streaming-in of gas with pressure p_{A}, until the downward-force prevails: the valve closes; already whilst p_{L}<p_{A} (long before).

Initial valve-contact occurs lightly due to the small acceleration over the short lifting height.

Opening and closing occurs securely due to the strong forces involved. Streaming-out & streaming-in of gas is reliable due to the very low RR volume of only a few μL (high pressure). Advantageous: brief streaming-out (through vent, e.g. using magneto- or piezo-electrics) & prolonged streaming-in via A-Stream flow resistance (e.g. as slippage; grooves; or adjustable via stream-throttle).

Advantageous: the fuel is fed in via a ring-groove in the DW adjacent to the VZ. It flows along the VZ (e.g. into slanted grooves leading downwards) to the valve-cone-seal and in front of blowholes, from which it is blown into the PK by the A-Stream. The A-Stream cools the valve and blows in at low temperature. Operation at very high PK-temperatures T_{K} is possible.

PC-Gas Systems Suitable for single-cylinder-, advantageous for three-cylinder-, perfect for (5, 7, 9) multi-cylinder-engines. Some examples for development (all gear pumps):

1> The PC-Gas is taken off from V_{3T} through offtake Vₐ via check valve or half-turning slotted-shaft. These offtakes from the cylinders together charge approximately half the tooth-gaps of a P-Pump, which delivers multiple times the amount required for the T_{K} target value. The excess gas streams through a stream-throttle back to the intake of the P-Pump. The throttle has a flow resistance DSw, with which the P-Pump always delivers up to a pressure >p_{K} (possibly for P-, V-, A-Stream). With adjustable throttling (via variable return-flow) T_{K} can be adjusted/controlled.

2> As per 1>, but with separate W- and/or V-Pump downstream from the check valves.

3> As per 1>, but with air vessel for buffering downstream from the check valves.

4> PC-Gas streams—as S-Stream—through the open valve-cone gap into the PK.

5> PC-Gas streams—as H-Stream—via TW-ring-groove through the valve-stem into the BR.

6> With small H-Stream flow resistance HSw and large V-Stream supply volume, a large H-Stream can be set (possibly separate V-Pump) and can thus be taken off as A-Stream via stream-throttle to the F-Pump. With adjustable branching off of H— into A-Stream, T_{K} can be controlled.

7> Without P-Pump, with channel ports to the WW, offtaking in the conical valve-guide.

8> Without Return-Push, PK-pressure super-elevated (p_{K}>p₃); processing only with PC-Gas.

9> With PKZ-output used to vary stream-throttle or return-pump: T_{K}-control.
Note: The valve Ve and/or check valve can be a conventional valve; but can also be a tap (slotted-shaft) or a slider or a flap.
The PKM works in any orientation; “top/bottom” only used for descriptive purposes.
The PKM is especially well suited to application in hybrid powertrain systems.

The Principle of the PKM Generates Many Derived Inventions. Suggestions:

### Process Chamber as Continuous Flow Processor Examples for Construction

The PK-Process begins in a broadened end of the fuel feedline, surrounded by a part of the Pore Wall. Sustaining the continuous process presents a challenge (even if A-Stream is used, which normally does not do any processing in the fuel feedline).

### Intake and Exhaust Ports Examples for Construction

Increased wear resulting from the piston rings sliding across the intake and exhaust ports can be avoided by constructing each of these ports as several narrow component-ports (slits), vertically and side-by-side in the cylinder wall: crosspieces prevent elastic bulging; possibly a wider central crosspiece. Multi-cylinders allow an enclosed crankcase (without port-access).

### Spring Valve Examples for Construction

For lifting of the valve the piston (with its contact area) makes contact with the valve-base; at a speed of around a few metres/second. Its speed of ascent decreases as the inverse-square of the distance from P₃. The piston opens the valve against the PK-pressure (p_{K}>200 bar). This is only a percentage of the PR-pressure p_{R} on the piston crown and thus does not cause any problems.

What could become critical however, is an impact with shock-acceleration, which with diminishingly small material-elasticity could outweigh the static pressure-forces. The suggested constructions offer elegant solutions:

The piston contact area and/or the valve is buffered or sprung. For practical purposes, the elasticity is achieved with a sprung valve-stem using conventional springs. Suited to this is a valve with a cylindrical valve-stem, movable with tight tolerances within a cylindrical valve-guide in the TW; and a conical valve-head above this, which provides the seal in a conical valve-guide in the TW.

The spring-stem of such a valve can be constructed in a variety of ways; including:

F1) The spring-stem consists of a series of disc-springs arranged on top of each other.

F2) The spring-stem is a spiral-spring; one- or two- or three-layered.

F3) The spring-stem is a cylinder with horizontal slits: each with 2 slits per level spanning <180° of the circumference; multiple slit-pairs always offset by 90° against each other. More than 2 slits per level are also possible.

The position P_{H}, in which the piston first makes contact with the valve, is symmetrical with P₄, in which the piston last makes contact with the valve (same height). The position P₂, from which the piston begins to lift the valve-head, is higher than P₄. From P_{H} the piston compresses the spring-stem (perhaps until the spring is fully compressed): at P₂ the valve-stem (shortened by P₂=P_{H}) is compressed; for instance into a cylinder (possibly smooth, solid) which slides with tight tolerance inside the cylindrical valve-guide in the TW. Up to P₂ the high PK-Gas-pressure p_{K} still keeps the valve pressed into the valve-guide: the valve-cone provides the seal. From P₂ the piston lifts the valve-head: at the latest when the spring is fully compressed, against any PK-pressure. With low p_{K} (reduced power output) a strong spring already begins lifting before it is fully compressed, without shock.

The flow resistance of TW-openings in the valve-guide to the PR through the TW (at and above the cone-shoulder) is to be kept so small that the valve-cone gap practically completely determines the valve flow resistance TSw (inversely proportional to the square of the lift). Rapid streaming in the gap causes cooling and negative pressure. The Fore-Shot is initiated gradually & transitions smoothly into the Return-Push. The elastic force stretches the Ve-stem and lifts the head further: to very low TSw, forcing PK-pressure to adjust to max. PR-pressure: p_{K}=p_{R-max}. (With higher TSw slower increases in pressure can be achieved; whereby: p_{K}>p_{R-max}).

In principle, instead of or in addition to the above, the contact area of the piston may also be sprung. However, the contact area is better suited for adjusting [during Test-Plant development] the positions—such as P₂, P_{G}, P₃— simply and exactly: achieved by setting a suitable thickness.

The spring-stem drastically reduces the shock-acceleration to only the very lowest part of the valve-base, the mass of which is to be kept small. The remaining spring-mass is only accelerated through the elastic forces, which have been absorbed by the piston which has already made contact. Only the lifting of the valve-head upon maximum spring compression still results in shock. This shock is small because by this point the speed of ascent is small.

An interesting consideration is a spring constant which increases from the valve-base to the valve-head; including no tendency for oscillation; including very light initial contact of the piston with lifting of the valve through elastic force without shock-acceleration on the valve-head. After lifting of the valve-head the rapidly increasing Fore-Shot results in the rapid equalisation of PR with p_{K}, following which the elastic force extends the valve to its full length. The valve-cone gap becomes large; thereby the Transit flow resistance TSw becomes small. The TSw remains small, because the elastic force keeps the valve extended up to P₄. The valve can be kept fully extended until after the culmination, and the Fore-Shot can be directed into the After-Push. Everything is achievable with smooth transitions. The springing or convex contact surface eliminates potential problems with canting.

To maintain low valve temperatures it is good to keep the combustion reactions away from the valve-body. A valve-stem compressed to a smooth cylinder (with tight tolerance inside the valve-guide) has a high flow resistance compared to the TW-openings in the valve-guide. Thereby hardly any PK-Gas or BR-Gas streams to the cylindrical valve-guide: practically no combustion reactions take place near the valve. If the upper part of the valve-stem is a smooth cylindrical surface (without slits) then even when the valve is fully extended hardly any PK-Gas streams to the cylindrical valve-guide.

The valve, which for approx. 8/9 of the cycle is pressed into the valve-guide which in turn is part of the Separating Wall TW, has barely higher temperatures than the TW and the ZW; despite the low heat capacity of the valve and its spring.

It is particularly advantageous to construct the side of the Ve-head facing the PK as a Pore Wall PW (concretely a Head Wall KW) with K-Stream possibly via V-Pump; mechanically lighter, chemically deposition-free; thermally cooler. This is even better if the V-Stream streams into the BR while the valve is lifted.

The valve-temperature is only weakly dependent on the temperature T_{K} inside the PK. Due to the Pore-Stream and highly heat-resisting ceramics, there is hardly any technical limit to T_{K}. It is expected that a temperature of approx. 800° C. will be targeted. However, even temperatures of 2000° C. could be manageable without problems.

### Consequences:

The above suggestions demonstrate that all valve-problems can be elegantly solved. They provide an indication of the variety of development possibilities of the PKM-principle.

### Exhaust Gas Recirculation and PK-Gas Examples for Construction

Exhaust gas recirculation is achieved by using a fraction of exhaust gas in the supply gas. Recirculation takes place with overstoichiometric to slightly understoichiometric, preferably stoichiometric exhaust gas. This does not inhibit the combustion reactions, because the BR-Gas and the PK-Gas are above autoignition temperature, whereby they react instantly on contact; even with slightest combustible portions. The rapid streaming (approx. 100 m/s) through the valve-gap results in cooling therein. This is advantageous for the valve-temperature, without affecting the reactivity: the deceleration on entry into the other gas restores the autoignition temperature and reactivity (the energy is conserved; only the entropy increases).

In a two-stroke engine with its combustion in every cycle, exhaust gas recirculation provides optimisation of the maximum temperature, which could otherwise possibly be too high. The PC-Gas always contains CO₂ & H₂O: through possibly Return-Push (with CO₂ & H₂O) and/or through offtake from V_{3T} (never totally without CO₂ & H₂O) and/or through exhaust gas recycled in the supply gas (how ever much of this gets into the PC-Gas). Regardless of the origin, two quantities of CO₂ & H₂O in the PC-Gas shall be considered:

| | | |
|---|---|---|
| PC-Gas: | ¹{ } = { } + 1CO₂ + 1H₂O + 6N₂ | ²{ } = { } + 2CO₂ + 2H₂O + 12N₂ |

| Lambda | Most energetic reaction in each case | with heat | cal/Fᵥ | gfuel/L |
|---|---|---|---|---|
| ¹{⅙} | → 2CO₂ + 1H₂O + 2CH₄ + 1C (10N₂) | +100.6 kcal | 1290 | 8 |
| ¹{ 1/12} | → 2CO₂ + 1H₂O + 4CH₄ + 3C (10N₂) | +106.8 kcal | 980 | 15 |
| ²{⅙} | → 3CO₂ + 2H₂O + 2CH₄ + 1C (16N₂) | +100.6 kcal | 850 | 5 |
| ²{ 1/12} | → 3CO₂ + 2H₂O + 4CH₄ + 3C (16N₂) | +106.8 kcal | 710 | 10 |
| ²{ 1/24} | → 3CO₂ + 2H₂O + 8CH₄ + 7C (16N₂) | +119.2 kcal | 600 | 17 |

CO₂ & H₂O entering into the PC-Gas does not change the reaction-energy, However it does increase the degrees-of-freedom F_{V}, which reduces the temperature increase ΔT_{K} (heating of greater mass). In concrete terms: ²F_{V}>¹F_{V}>F_{V}, whereby ²ΔT_{K}<¹ΔT_{K}<ΔT_{K}.

By nature a lowering of PK-lambda reduces the temperature increase ΔT_{K}.

The temperature increase ΔT_{K} builds on the infeed-temperature (temperature of the process substances as they are fed in). The Return-Push enters the PK in a hot state and/or the PC-Gas carries heat from V_{3T} on into the PK (in case of counterflow heat-exchanger). The actual PK-temperature T_{K} can be much higher than the temperature increase ΔT_{K} achieved with only reaction-heat Q/F_{V}. With T_{K} values: >800° C. the reaction begins to shift, and >1100° C. there is an intensive shift towards methane, cyanide and CO.

Remarkably high exhaust gas recirculation and/or low PK-lambda results in practicable PK-temperatures T_{K}. PK-Gas with lambda of only 0.05 results in ΔT_{K}>600° C., which—with advantageously setup infeed-temperature—results in a suitable PK-temperature.

However, even high temperature and large amounts of gaseous soot would not be a problem for the PKM.

### PKM-Pump-System Examples for Construction

Amongst the many varied possible pump-systems (also those with lobe- and piston-pumps, amongst others) only systems with gear pumps shall be illustrated. To stimulate future research, at least one practicable type of system is presented:

The flux-dose (fuel, which is fed into the PK per cycle) is set from maximum to zero by a D-Pump. It doses the exact volume at any viscosity. It can be ideally controlled. Only friction energy is required to turn it; advantageously quasi-synchronous: variable reduction from 1 to 0 times the crank speed. The other pumps are synchronous: i.e. firmly coupled to the crankshaft, invariably turning in fixed relation (possibly constant reduction). The PKM is suited to synchronous pumps; in concrete terms: any slippage of the F-Pump is compensated with the supply-stream via the HD-line. Any PC-Gas-pump always has to pump the same amount of PC-Gas/cycle; even with reduced flux-dose (for reduced power-output at the same specified lambda), because in this case the amount of supply gas is compensated by increased recirculation of exhaust gas. The lambda-specification and exhaust gas recirculation requires some development. This is simple in comparison to that required for the DsM or OtM. The PKM has practically no problems with scavenging, ignition and timing.

The lambda-specification effectuates the inevitable setting of all operating states in the PKM. For maximum power-output preferably lambda 1 should be specified. For reduced output even overstoichiometric conditions produce hardly any nitrous oxides. Hence the gas-delivery rate of the pumps is non-critical. However, with deviations different PK-temperatures are set up, which facilitates control of T_{K}.

As each of the two gas-components brought together is above autoignition temperature, the PKM operates with any portion of exhaust gas in the supply gas, facilitating optimisation to any level of power-output. The free parameters allow almost any reaction-function to be set. Suitable for two-stroke engines e.g.: decreasing flux-dose from maximum to 10%, with intake air in the supply gas from 80% to 10% (even only 1% fuel in the PK-Gas with 1% intake air in the supply gas reacts instantly on being combined). The PKM-two-stroke with the say 20% exhaust-fraction is still considerably more effective than the four-stroke, because it produces work in every cycle. With this amount of exhaust gas remaining during the changeover (P₅₁) there is no problem with scavenging.

All synchronous pumps can be accommodated in the same pump-block; on the same shaft, in possibly adjoining chambers. Some connections may be accommodated in the dividing walls. Gears have identical radii. The different delivery volumes are due to the lengths of the gears and size of the teeth. The delivery volume of the lubricant pumps (possibly E- & U-Pump) is too small for this arrangement. However, they may be accommodated in the same pump block using planetary reduction gears. Lubricant pumps provide lubrication for other pumps which are located in the same block.

### Fuel-Pump: Examples [Specified in Volumelcycle]

The delivery of fuel can be continual & ought to be precisely adjustable; at all viscosities of every fuel (provided that it is actually usable). The delivery must take place from atmospheric pressure (1 bar) up to the pressure of the Process Chamber; e.g.: up to the almost constant maximal pressure of the Compression Chamber (e.g. 200 bar).

Gear pumps are well suited. However, their flowrate XFv is reduced by slippage-backflow: within, the gear-teeth do not interlock with complete volume-displacement and additionally the sliding-seal is not perfectly tight. The slippage-backflow depends on the viscosity and increases with the pumped pressure gradient. The slippage-backflow becomes almost diminishingly small with low pressure gradients.

Perfect Fuel-Flux pumping occurs in two stages, suitably with gear pumps: at the fuel entrance with a D-Pump (Dose-Pump) & followed by an F-Pump (Flux-Pump) placed in series; whereby: The FFv of the F-Pump is multiple times the DFv of the D-Pump. The fuel dosed by the D-Pump is pushed into the PK by the F-Pump. Between the D- & F-Pump the HD-line (behind D-Pump) discharges gas drawn from a low-pressure gas space. The F-Pump first of all takes in the Fuel-Flux delivered by the D-Pump. With greater FFv than DFv the F-Pump additionally draws in gas from the HD-line, whereby the pressure behind the D-Pump becomes equal to the pressure in the HD-line. If the HD-line leads from the crankcase, the pressure gradient at the D-Pump becomes very small (<1 bar): no slippage at the D-Pump. If the FFv is greater than DFv by an amount more than the slippage of the F-Pump, the F-pump always pumps the precise amount of fuel dosed by the D-Pump into the PK (how ever high the slippage of the F-Pump may be).

Advantageous: FFv=3×DFv (DFv with fully revolving D-Pump for maximum dosage).

The Fuel-Flux can be precisely set using the speed of the D-Pump; constant at any viscosity. The small work output of the P-Pump offers simple electronic control of its speed. Changes take effect without delay (tooth gaps are always full).

By switching the HD-line from the crankcase to the fuel tank, the F-Pump draws in additional fuel and pumps it into the PK: for severalfold power-boosts (e.g. assisting vehicle acceleration for brief periods when starting from standstill or overtaking).

With the HD-line vaporised lubricant fuel for instance may be extracted from the crankcase. With e.g. FFv=3×DFv there is sufficient extraction in case lubrication occurs via continuous fuel influx: hardly any lubricants escape through the exhaust port.

If low-pressure gas (crankcase) of say twice the volume of fuel is taken in, then this is compressed on delivery by the F-Pump to <1% of the fuel-volume (from ˜1 bar to >200 bar). Gas-intake through the HD-line to compensate F-slippage does not change the dose of the K-Flux. Addition of gas behind the F-Pump provides beneficial results:

Advantageous: an Adding-Stream as a gas which streams into the K-Flux directly behind the F-Pump; with pressure of the K-Flux into the feedline to the PK. Hence the K-Flux may turn into foam. This foam: flows more quickly from the F-Pump into the PK; is less viscous; distributes itself better in the PK; has a lower tendency to form KTH.

With a Cylinder-Valve, shortly after the fuel is blown into the PK the Process-Reaction sets in, the lambda of which is given by A-Stream+W-Stream (e.g. ¾+¼). Advantageous: rotationally-symmetrical, flat-topped VZ which slowly rotates; which when lifted closes flush at the top vent and along the remaining edge contacts a rounded surface: forming the Ring-Space RR for rapid streaming-out, followed by gradual streaming-in of gas; firstly a p_{L}-drop for valve-lifting via p_{R}-jump, followed by a p_{L}-rise until valve-lowering occurs.

The streaming-in of gas occurs e.g. via AZ-slippage, -holes or -grooves. The streaming-in occurs e.g. through lines via stream-throttle, for adjustment of A-Stream flow resistance. There-by both the length of P₂₄ and the correspondingly self-adjusted PK-pressure p_{K} are controllable.

Adding-Stream as Process Gas simply branches the PC-Gas-stream into the PK, which does not alter the lambda in either the PK or the engine overall. A-Stream: e.g. from check valve via separate A-Pump (gear pump), which only needs to handle the excess pressure; or from shared P-Pump, behind which (via respective flow resistance) various PC-Gas-streams carry on separately; or branched off from V-Stream via stream-throttle.

If an Adding-Stream is used less Return-Push is required. E.g. with 200 bar an Adding-Stream=5-times the Fuel-Flux results in PK-Gas with approx. lambda ⅛. Pore-Stream together with Adding-Stream might be able to replace the Return-Push completely.

For advanced future development: coverage of the PK-lambda with Pore-Stream+Adding-Stream; position P₂ shifted close to position P₃; only about or shortly after P₃ the PR-pressure closely approaches the PK-pressure (p_{R}→p_{K}), but does not exceed it; the Fore-Shot transitions directly into the After-Push (no Return-Push).

Power-Output Variation This is problematic; especially for motor vehicles.

Decrease: The engine power-output can be shut off immediately by opening the fuel feedline to the PK downstream of the F-Pump: the PK-Gas along with the approaching fuel escapes. This is advantageously collected in a container, with delayed recirculation to the inlet side of the F-Pump; or via the HD-line into the crankcase. Supply gas which after the outflow of PK-Gas continues to be pushed into the PK, streams out of the open fuel feedline; cleaning it.

Increase: To provide a sufficiently quick, advantageously smooth increase in power-output: shortening of the Zz-dependent setup duration to the new stationary state by boosted fuel-supply (for instance via the HD-lines). Shortening of the setup duration of the PC-Gas (e.g. from V_{3T}) via direct charging (without air vessel) from approximately one half of the tooth gaps in the entrance of the P-Pump.

Many technical solutions exist for the reliable decreasing and increasing of power-output.

### Lubrication Examples for Construction

Lubrication is provided with lubricant: engine lubricating oil or fuel containing such. Lubrication is required for the reduction of wear due to sliding friction. Other causes of wear are to be eliminated independently: thermal stress in two-stroke engines is avoided by keeping the intake air at the same temperature as the exhaust gas. This can be implemented effectively using counterflow heat exchangers. In combination with a turbocharger—which provides advantages in any case—there is wide scope for realisation. All piston engines require a thin layer of lubricant between sliding surfaces. Older lubricating systems indicate the problem:

Liquid lubricant (mostly lubricating oil) is situated in a pool at the bottom of the crankcase. The crankarm & crankpin splash some of the lubricant. The splash-spraying effect lubricates the sliding surfaces of the bearings, piston & cylinder by wetting. Investigations undertaken decades ago established that most of the wear in engines occurs in the first minutes after startup: because this is the time required for the lubricant to be sufficiently distributed over the sliding surfaces. Synthetic oil is more persistently viscous and adhesive: the lubricating film does not need to be continually re-established.

Newer systems use a pump to transfer the lubricant.

In contrast, the following suggestions introduce a system whereby a sufficient lubricating film is established after the first few cycles; independent both of previous operating conditions and associated temperatures. Common to all suggestions are the following:

The lubricant is introduced onto the Cylinder Wall ZW via entry-points: These are small openings in the ZW; advantageously from narrow lines which are directed steeply downward in the ZW. The entry-points are positioned—preferably in the crank-plane—in P_{H4} below, and in P₅₁ above the piston rings, which slide over the top of them.

Entry below the piston rings: for introduction of lubricant beneath the piston rings in the space between piston & cylinder wall. The inserted lubricant is smeared upward and downward over the sliding surfaces and then swept into the pool at the bottom of the crankcase (possibly extracted by suction).
Entry above the piston rings: for introduction of lubricant above the piston rings; mostly smeared over the sliding surfaces; a small amount combusts as fuel above. This combustion does not shift the lambda value, however does lead to loss of lubricant. Entry of lubricant above the piston rings is to be minimised. Entry below the piston rings is fully sufficient.
The height of the entry-points determines the introduction of lubricant into the ZW. Lower positions extend the duration for entry below the piston rings & reduce any tendency of the lubricant to be pushed back into the lubricant supply lines by the PR-pressure PR. Higher positions result in improved smearing across the upper inner cylinder wall. A position at the midpoint of piston lift is always practical.

Advantageously each cylinder has two entry-points, one on each side in the crank-plane, for instance at half the swept height. At these entry-points the PR-pressure normally (say without turbo-charger) attains barely 3 bar during compression, and less than 10 bar during expansion. Pressure of a few bar is sufficient to introduce lubricant through the entry-points. In relation to the fuel consumption approximately 0.2% lubricating oil is to be introduced; or barely 1% of fuel that contains lubricating oil. For a medium-size motor vehicle this equates to approx. 0.2 mg/cycle of lubricating oil or 1 mg/cycle of lubricant as fuel containing lubricating oil. Lubricant entry can be achieved for instance via a synchronous gear pump.

In the PKM a lubricant pump is not necessarily required. The fuel containing lubricating oil is taken off e.g. behind the F-Pump—before possibly A-Stream Supply Line—into entry-lines to the entry-points. With the individual flow resistances the distribution of flux to the individual entry-points can be adjusted. This can occur via common offtake with high flow resistance followed by a branch in the lines. Thus for multi-cylinder engines the lubricant enters that cylinder which contains the lowest backpressure at the time; i.e. in P_{H4} and P₅₁.

There is a tight tolerance-gap for movement of the piston in the cylinder. As the crank turns (assume clockwise rotation for discussion) the (length-dependent) angle of the connecting rod varies about the vertical. Thus the force on the piston has a strong sideward-component. This results in a pressure-side and a gap-side. On the pressure-side (during compression P₀₃ on the right side, during expansion P₃₆ on the left side) the piston is pushed tightly against the Cylinder Wall, over which it is displaced in a sliding fashion. On the gap-side the tolerance-gap is opened up to twice the width of the tolerance-gap on the opposite pressure-side.

The entry of lubricant requires a small flow resistance. If the piston has a completely smooth sliding surface it closes off the entry-point on the pressure-side completely, & on the gap-side leads to low transfer of lubricant if the transfer needs to occur into too small an area around the entry-point.

However, effective lubricant entry between piston and ZW can be achieved—on the right as on the left side of the piston—by a vertical groove in the piston-surface, to which the entry-point in question has access whilst the lowest piston ring is sliding above the entry-point. Suggestions for design:

The vertical groove extends from just below the lowest piston ring to just above the lower piston end. The narrow groove does not reduce the sliding surface significantly. It is covered by the ZW during the entire cycle; at the exhaust- and intake-ports by the central crosspiece. Reduction of the pressure in the groove to that in the crankcase is achieved by a hole leading from the groove to the piston-interior, which at the same time directs excess & vaporised lubricant via the connecting rod to the crankcase and thus lubricates the crankpin & bearings. Lubricant entry below the piston rings occurs: on the pressure-side only into the groove; on the gap-side also (from the groove) into the gap. The transfer into the gap is supported kinematically for instance by meandering of the grooves and for instance entry-points with a pair of side-by-side openings on each side. It is practical if the entry-lines through the ZW are oriented at a steep downward angle (wetting of the walls).

The pressure required for lubricant entry can be achieved with a gear pump, which delivers a defined volume of lubricant per cycle, whereby the pressure required by the flow resistance arises by necessity. The flow resistances of the entry-lines determine the distribution of lubricant. Low flow resistance increases the effectiveness of the backpressure of the PR-Gas (possibly to a level where lubricant is pushed back into the lines). Lower flow resistances reduce the entry of lubricant above the piston rings (possibly to zero) and increase the entry of lubricant below the piston rings. Presumably, periodic intrusion of exhaust gases into the entry-lines is not harmful and can be avoided with check valves in any case. For design, the effectiveness of lubricant distribution is critical. In multi-cylinder engines lubricant flows with lower flow resistance into that cylinder, in which the lowest backpressure occurs at the time. With single cylinder engines lubricant always enters at constant delivery volume. However—on average—even then there is a disproportion between the lubricant entry on the right side and that on the left side of the ZW. Advantageous: via small flow resistances more lubricant can be introduced on the expansion-pressure-side (left-hand-side for clockwise rotation).

Entry of lubricant is practicable with lubricant-recirculation: via a recirculation pump from a lubricant pool at the bottom of the crankcase into entry-points and via the piston back into the pool. Any losses are advantageously covered by addition of fuel containing lubricating oil. A small proportion of lubricating oil in the fuel is sufficient, because during operation the lubricating oil in the pool is enriched, in that it vaporises less than the lighter fuel fractions. Addition of fuel used to compensate lubricant losses advantageously occurs before the recirculation pump. Constant addition is possible if the splash-spray is drawn off, as this increases sharply when the lubricant pool level is increased only slightly, which in turn regulates the pool level to a stable value.

With coverage of losses using fuel containing lubricating oil, recirculation is beneficial in which excess lubricant is recirculated into the fuel-feedline for engine operation. Recirculation occurs without loss of fuel or a change in the overall lambda. However, it does cause two problems. The problem of lag (via the large crankcase) is the less serious, the less fuel is recirculated (approx. 0.3% to 3% recirculated fuel should be non-critical). Critical on the other hand is the problem of fluctuations in the recirculation. The pool from which lubricant is recirculated is in vigorous motion during operation (undulates & wobbles), such that achieving a sufficiently steady offtake—for recirculation into the K-Flux—is problematic. This continuity-problem, amongst others, is ideally solved by a new two-stage pump system:

The new two-stage pump system has two gear pumps with identical or similar delivery volume: Entry-Pump E-Pump+Circulation-Pump U-Pump. Lubrication occurs via lubricant from a pool at the bottom of the crankcase.

The E-Pump directs the lubricant via entry-lines with suitable flow resistances into the entry-points. This lubricant lubricates the sliding surfaces, whereby the unlost component reaches the lubricant pool. The U-Pump extracts lubricant from the pool and/or gas from above the pool. The U-Pump delivers this extracted material to the entrance of the E-Pump, into a confluence with a line from the fuel-tank. At the confluence all of the lubricant delivered by the U-Pump is taken in by the E-Pump & delivered into entry-points. However, gas delivered from the U-Pump is not taken in by the E-Pump, but instead is separated; before or at the confluence the gas bubbles off, e.g. into the line from the fuel-tank.

The volume of liquid delivered by the E-Pump is reduced by the amount of gas-volume delivered by the U-Pump. The E-Pump which takes in the full volume of liquid is thus forced to take in the volume-deficit from the fuel-line; hence: the exact amount of lubricant which was lost during lubrication, is taken in by the E-Pump as replenishing fuel from the tank.

The two-stage pump system is effectively a recirculation of lubricant from the pool, with stabilisation of the pool level to a target value, which determines the height of the offtake-line (circulation-point) from the lower crankcase. Lubricant-losses are replenished by fuel containing lubricating oil. The convergence of the target pool-level is always the same when averaged over many cycles; even if the U-Pump takes in only liquid or only gas for extended periods. Motion of the pool-level is no problem. At the same time the lubricating oil in the pool is continually enriched due to the fact that primarily the lighter fractions of the fuel are introduced to the K-Flux. This introduction occurs via the HD-line, which originates from the upper crankcase and only extracts gas and spray. Thus there is no discontinuity problem for the K-Flux.

The two-stage pump system acts ideally: There is always—from the first cycles—a constant amount of lubricant-entry into the entry-points; regardless of the height of the lubricant-pool-level (even if below the offtake); regardless of the quantity of lubricant-entry (whether EFv & UFv—E- & U-delivery-volumes, respectively—are 1% or even 9% of the DFv, inasfar as there is a necessary minimum); regardless of the amount of lubricating oil in the fuel (whether 1% or 50%, due to enrichment).

The system is especially suited to the PKM, which can contain oils of any kind, which are liquid, combustible and processable. Crude oil for instance would only require desulphurisation.

The system is incomparably practical: immediately effective, even at low temperature and after interruptions of any duration; no special requirements for fuel; no need for refilling of lubricating oil; continual self-replenishment, no need for oil changes or maintenance.

Startup-Ignition and Temperature-Control with the PKZ

The Process Chamber Ignitor PKZ is a blocking oscillator controlled by a Peltier current. In the PKM the PKZ: ensures ignition within the first few cycles (extremely low startup-work); and controls temperature T_{K} within close to an adjustable target value (e.g. 800° C.).

The thermal contact protruding into the PK is heated by PK-Gas and by the blocking oscillations, which become infrequent when the target-temperature is approached. If for instance the Pore-Stream is designed to reduce when the blocking oscillations become less frequent, a control loop results, with which the PK-temperature T_{K} is regulated.

Connecting two different conductors to each other, results in a Peltier voltage approximately proportional to the difference in contact-temperatures; dependent on the material: metal pairs of contacts up to a few dozen μV/Δ° C. Metal pairs of contacts are often used for measuring temperature. Hot bulbs (amongst other things for ignition of gases) are often heated by transformers in the secondary-circuit. Specific to the PKZ: In the secondary circuit of a transformer driven as a blocking oscillator there is a thermal contact with relatively high resistance. This thermal contact is heated by the alternating current of the blocking oscillator and operates as a hot bulb. However, it is also heated from its surroundings; specifically by the PK-temperature T_{K}. The same thermal contact with its Peltier voltage superimposes a direct current onto the alternating current, which magnetises the transformer core to saturation. Consequently, once a critical temperature is reached no blocking oscillations can start: a small increase in temperature reduces the steady oscillation to zero oscillation.

Control of T_{K} via PKZ: achieved using the frequency of the blocking oscillations, through control-output for instance from a bridge-rectifier from the primary winding. Example 1: via stream-throttle, which reduces the amount of delivered PC-Gas via a shunt at the P-Pump, in that recirculation is low with zero control-output, and recirculation increases with increasing control-output. Example 2: via stream-throttle from the valve to the F-Pump, branching off A-Stream from the H-Stream, and thus with zero control-output a large amount, and with increasing control-output a lesser amount of PC-Gas streams into the K-Flux.

The blocking oscillations which transform the heating power start by the self-excitation of, for instance a transistor bridge from a DC voltage source. In extreme positions extra-impulses serve to prevent locking. To allow gas to be fed through and heated a thermocouple constructed as a gap-tube is advantageous: for instance a tube split lengthwise that tapers in towards the contact-bulb with the halves made of Ni and CrNi.

Commonly used pairs of contacts are sufficient for a Peltier-bulb; operating with reserve capacity even with simple transformer cores; and operating up to high temperatures. The PKZ-system introduced here is illustrated by concrete example with a design suited for PKM-ignition: this is a robust and cost-effective design, but further optimisation is possible.

### The PKZ as Ignitor for the PKM:

The PKM works with all fluid fuels; independent of their viscosity and vaporability. All that is needed is a pump that delivers the fuel into the PK: for vaporisation and processing at reasonably high temperature. A startup-ignition system guaranteed to work with all fuels does however need to be established; for example:

In the middle of the top of the PK-dome for instance, a gap-tube protrudes through the thick Pore Wall PW into the mixture which is to be ignited. At the end of the gap-tube is the thermal contact which is maintained above ignition-temperature; amongst others a chromium-nickel/nickel thermocouple is suitable for this purpose:

| | | | | | | | | | | |
|---|---|---|---|---|---|---|---|---|---|---|
| ° C. Temperature | 1200 | 1100 | 1000 | 900 | 800 | 700 | 600 | 500 | 400 | 300 |
| mV Thermoel. Voltge | 49.0 | 45.2 | 41.3 | 37.3 | 33.3 | 29.2 | 24.8 | 20.6 | 16.4 | 12.2 |

For ignition, the gap-tube acts as a hot bulb. Ignition is achieved more readily if the air streaming through it is heated. Some of the air pumped through the PW streams through the gap-tube, which contains a thin air-channel (<½ mm) conically narrowing towards the thermal contact. Air streaming at 1 mg/s is heated to >800° C. by <¾ Watt; reliable ignition.
The gap-tube is placed in the secondary circuit of the transformer of a blocking oscillator, with feedback RK via the inductivity of the transformer. If its core saturation exceeds a threshold, the RK is stable; otherwise the RK is unstable. The Peltier current J_{P} drives the core into operating-saturation. The counter-current J_{G} desaturates—after conclusion of the downsweep—approximately smoothly to the threshold. If J_{G} does not shift to the threshold, then the system remains stable in a rest-state. If J_{G} shifts beyond the threshold, then the system transitions unstably to the upsweep: to counter-saturation. At this point there is normally alternation of upsweep and downsweep: to operating-saturation. At this point there is normally cut-off with drifting of the counter-current J_{G} to the value of the position-current J_{S}. During the upsweep and the downsweep power is transformed into the secondary circuit. During saturation no voltage is transformed, and hence there is no heating current J_{H}, and hence the operating-current J_{A} only consists of magnetising current J_{M}. If there is a high counter-current, the blocking oscillator can become stuck in counter-saturation: in a dead-state. This may be triggered by a current-impulse—from c-discharge—to the downsweep; a capacitance c is charged via a resistance r until a thyristor t fires (in itself or via varistor). Charging-current <reset-current for thyristor t.
The heating current J_{H} heats the thermal contact (main-secondary-circuit-resistance): either continually (<800° C.) or intermittently (=800° C.) or at rest (>800° C.).
The blocking oscillator has more power than required for heating to a target value (e.g. 800° C.): for rapid heating (e.g. 5 W): for successful ignition during the first compression strokes. The running operation is intermittent, with rest durations many times greater than sweep durations.

### Peltier-Thermocouple and Transformer-Core

The Peltiercouple-bulb must be sufficiently temperature-resistant and deliver a sufficiently high Peltier current at the target temperature, so that the transformer core-material is magnetised to a suitably high level of saturation, in which variations in current induce sufficiently small voltages: core-material with high permeability and a sharp knee.

Even the familiar chromium-nickel/nickel-pair delivers such high Peltier currents, that the blocking oscillator can be easily and simply implemented. This CrNi/Ni-pair is usable up to 1600° C. At 800° C. it already pushes e.g. VACOPERM 100 into such a strong oversaturation, that very accurate adjustment is possible; furthermore with a large reserve. This laminated silicon-iron abruptly enters saturation with approx. 30 mA/turns at 0.74 Tesla. Presumably even a Goss-lamination is sufficient; for instance with the core PMz 47.

To introduce developers to the technology (for simplification, size-reduction, cost-reduction) a concrete system is shown: with robust and non-critical circuit elements for simple and reliable operation: 800° C. & 6 Watt with 0.15 mm VACOPERM 100. However, for 800° C. approx. <¾ Watt are sufficient. To attain a sufficient field gradient (approx. 200 Tesla/s), a purpose-built 0.15 mm Goss-lamination is adequate.

### System as Illustrated (Bridge)

Transformer Core: with 0.15 mm E-shaped plates with yoked semi-open lamination:
VACOPERM 100.

| | | | |
|---|---|---|---|
| widtlength 36 mm:h 30 mm: | window 7 mm; | middle limb 6 mm; | outer limbs 5 mm. |

| | | | |
|---|---|---|---|
| Parts P of the system: | window 16 mm; | yoke 10 mm; | (E-sheet limb 26 mm). |

| | | | |
|---|---|---|---|
| P′ & P″ oscillators | P* controller | P″ positioner | t, v, d, r, c impulse |

| | | | |
|---|---|---|---|
| Circuit Elements: | T transistor | t thyristor | V and v varistor |

| | | |
|---|---|---|
| D and d diode | R and r resistance in Ω | C and c capacitance in nF |

Transistors with approx. 100-fold current amplification, whereof only 20-fold is utilised

| | | | |
|---|---|---|---|
| Windings: | heating circuit H = 1 | primary W = 40 | secondary W′ = W″ = 20 |

| | | |
|---|---|---|
| Voltages: | car-battery 12 V; | taken as: +6 V & −6 V |

| | |
|---|---|
| voltage U′ at W with R₂′ | voltage U″ at W with R₂″ |

| | |
|---|---|
| | J_{W} heating AC-current |
| Currents in heating coil H: J_{P} Peltier current | |
| Currents in primary winding W: | |

| | | |
|---|---|---|
| thermocurrent | J_{T} ≈ J_{P} · (H/W) | (threshold-value of J_{G} determined by J_{P}) |
| heating current | J_{H} = J_{W} · (W/H) | (J_{W} is the effective H-AC-current in W) |
| magnetising current | J_{M} | (in W this is the AC-magnetising-current) |
| operating-current | J_{A} = J_{H} + J_{M} | (total AC-current in W) |
| counter-current | J_{G} | (the J_{T} opposite-magnetising DC-current) |
| position-current | J_{S} | (max. value of J_{G}: adjusted for temperature-control) |

### Operation:

Effective voltage at W: >10 V; for transformation to H with 25 m V.

Heating circuit R=10 mΩ: gap-tube 8 mΩ: otherwise 2 mΩ (coil+wire)

The heating-circuit-resistance R presents a specific challenge for developers. R=10 mΩ yields heating-circuit-power N_{H}=6.25 Watt; 5 W at the thermal contact.

NiCr/Ni-thermocouple at 800° C. with 32 mV; results in Peltier current 3.2 A.

Consequently: operating-current J_{A}<700 mA position-current J_{S}=80 mA
Core-diameter 50 mm² (beneath window). Magnetising-length 18 mm (only to 16 mm saturation; within <1 mm no more saturation in the yoke) Peltier-excitation 1.8 A turns/cm; in relation to the saturation-excitation:

60-fold with VACOPERM 100 (0.74 Tesla); 6-fold with specialised-Goss (1.8 Tesla).

Upsweep or downsweep: through 2×0.74 Tesla over ½ cm²; hence 7400 Mx (Maxwell). These are ˜1 mVs/turn. For 40 turns with 10 V: upsweep=downsweep−duration 3 ms. Duration of upsweep+downsweep=sweep−duration 6 ms (adequate frequency ⅙ kHz).
Transition (μs): W′ T₁′-RK>1; threshold with steeper magnetisation

With J_{T} slightly larger, when C^{T} smaller & quicker transition; →upsweep

Upsweep (3 ms): J_{G}→0 because V*(5V)>U′ & D* is open; →counter-saturation
Alternation (μs): smaller C′&C″ is possible if saturation is abrupt; →downsweep
Downsweep (3 ms): J_{G}=0 because U′<−5 V in fact draws off D*; →operating-saturation
Cut-off (μs): J_{G}=0; D′&D″ blocks upsweep; →drifting with U″ (4 μs)→−4V
Drift (90 μs): J_{G} drifts to the threshold: 0 to J_{S} (R*C*); alternatively:
Transition if J_{S}>J_{T} (<800° C.); Pause in rest-state if J_{S}≦J_{T} (>800° C.)
End of return-sweep, drifting into rest-state: position-resistance R″ positions via V″ in T″ a constant position-current J_{S}, which briefly (30 μs) discharges C*. Delayed by R*C* (90 μs) T* takes up the current J_{S}, until T₁′ current J_{S} takes over. If J_{T}≧J_{S}, U″—increasing from −4V—comes to rest at approx. 0V. If J_{S}>J_{T} then the transition starts.
Current-Impulse: triggers during dead-state to the downsweep (ineffective during rest-state): resistance r charges capacitance c (e.g. ¼ s). When a voltage u (e.g. 6V) occurs at thyristor t, it fires: impulse via c to T₂′. Upsweep discharges via varistor v & diode d.
The PKZ has been described in concrete terms for startup-ignition and standby-operation of engines. The stated reference values are to be ascertained by experimentation. The number of oscillations is representative of the surrounding temperature, which may thus be controlled. The PKZ has many applications with any required power-output; from milliwatt to kilowatt.

### LABELS

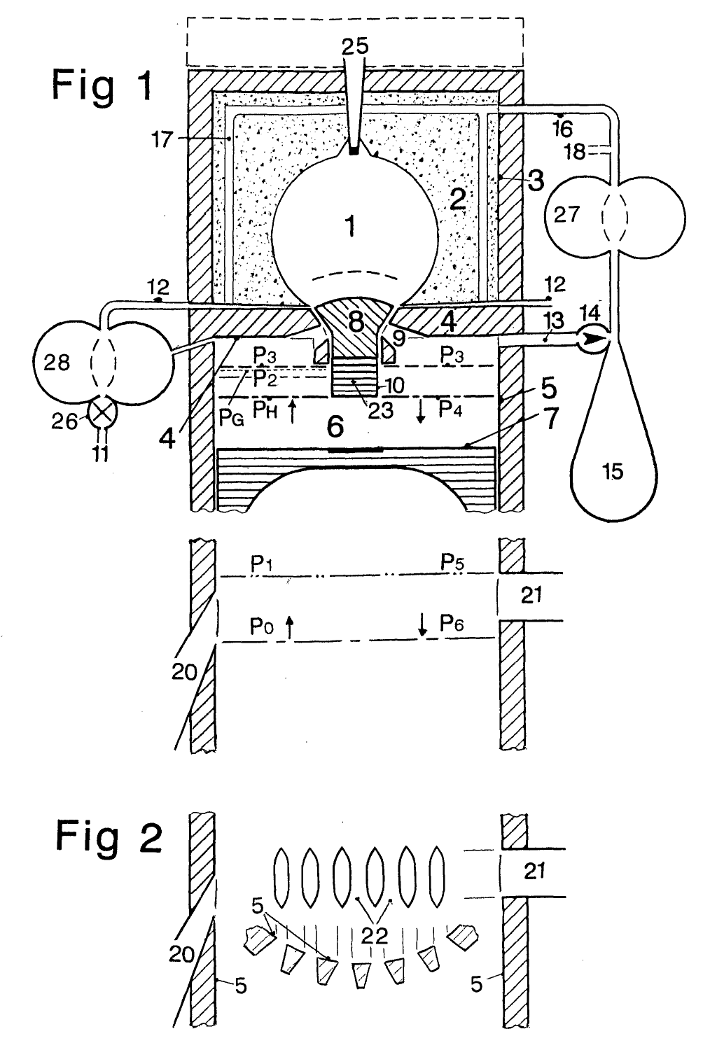

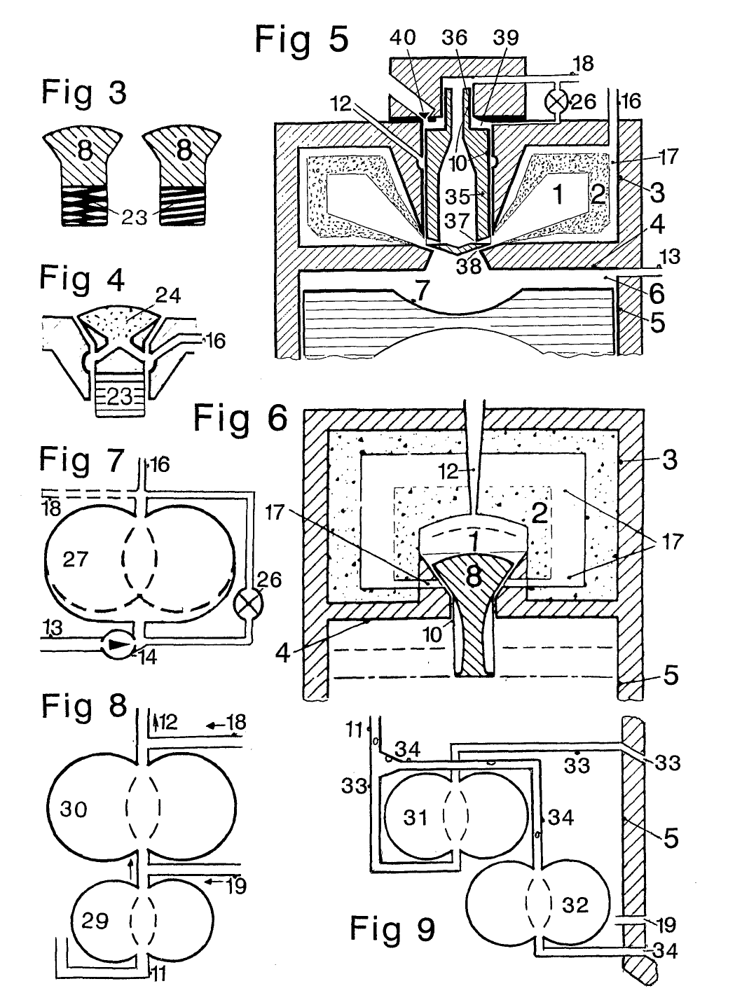

FIGS. 1 to 9 are schematic only, for illustration & explanation of the principle. Not work drawings, For clarification not drawn to scale.

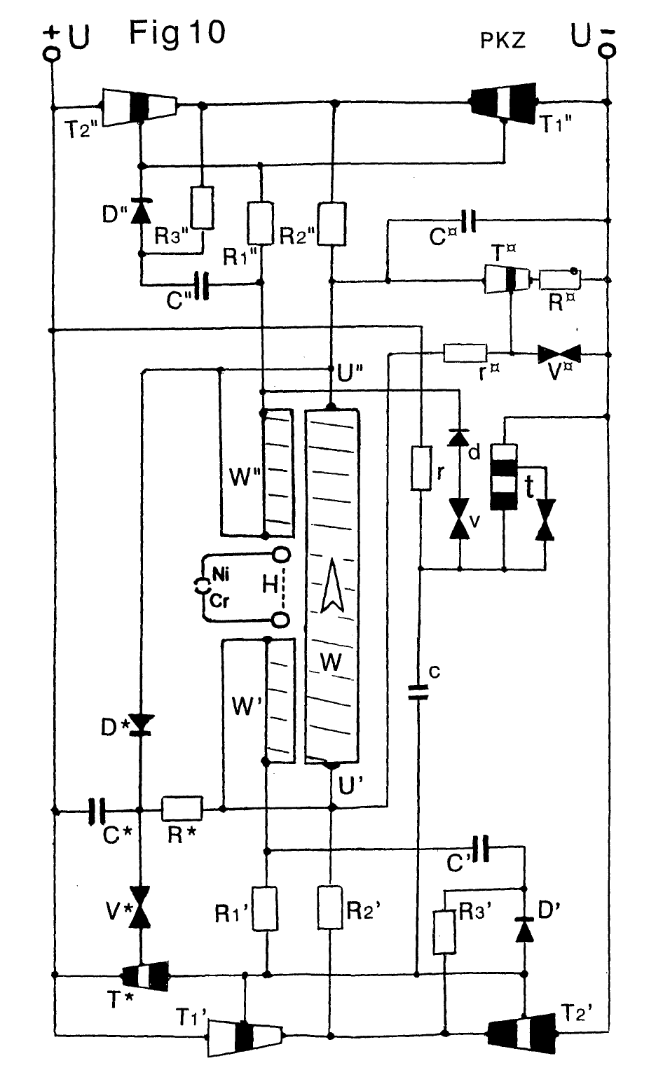

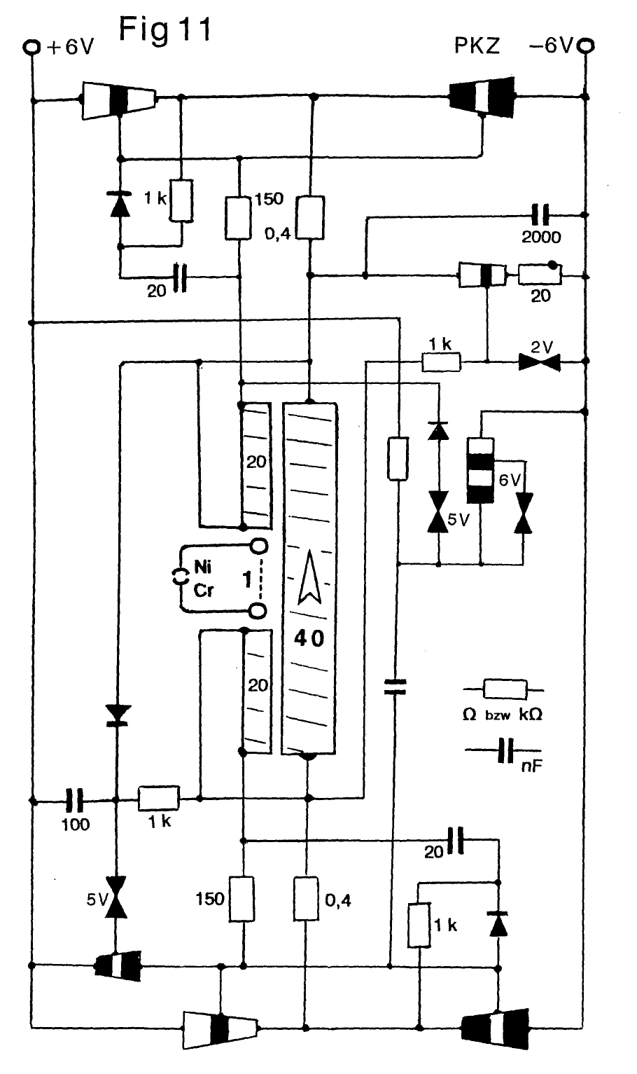

FIGS. 10 & 11: with international notation & concrete values, respectively,

Positions of the Piston Crown each being the lower limit of the Compression Chamber

| P₀ | Beginning of cycle (piston at bottom dead centre) = | | P₆ end of the previous cycle |
|---|---|---|---|
| P₁ | Beginning of compression (PR closure) | | end of exhaust gas/supply gas changeover |
| P_{H} | Beginning of contact of piston with valve | | initial piston contact |
| P₂ | Beginning of vaive-head lift & | | beginning of Fore-Shot which lasts up to P_{G} |
| P_{G} | End of Fore-Shot (equality p_{R} = p_{K}) | | beginning of Return-Push into the PK |
| P₃ | Culmination (piston at top dead centre p_{R-max}) | | maximum valve-lift |
| P₄ | Closing of valve through piston ‘lift-off’ | | beginning of expansion |
| P₅ | End of expansion and work phase | | beginning of exhaust gas/supply gas changeover |
| P₆ | End of cycle (piston at bottom dead centre) = | | P₀ beginning of next cycle |
| 1 | PK Process Chamber for processing, i.e. conditioning of the fuel | | |
| 2 | PW Pore Wall around the PK. Through this the Pore-Stream enters the PK | | |
| 3 | DW Pressure Wall. The DW encloses the PW and the PK: holds the PK-pressure | | |
| 4 | TW Separating Wall lower TW-surface is always the upper limit of the PR | | |
| 5 | ZW Cylinder Wall with ZW-inner-surface, which delimits the PR | | |
| 6 | PR Compression Chamber enclosed by ZW, TW and piston crown | | |
| 7 | Piston Crown (PR-limit); whilst Ve open, PR acts as Combustion Chamber BR | | |
| 8 | Valve Ve head provides seal in valve-guide; valve-lift for Transit-Stream PK/BR | | |
| 9 | Openings TO in the Separating Wall TW; via Ve-gap: Transit-Stream PK/BR | | |
| 10 | Valve-Sliding-Surface as a Ve-stem in the TW-Ve-guide/as a valve-cylinder in the DW | | |
| 11 | Fuel Line from the fuel tank to the pump (fuel- or lubricant-pump, as applicable) | | |
| 12 | Fuel Feedline into the PK (e.g.: above valve edge or into DW-ring-groove, as applicable) | | |
| 13 | Offtake of PC-Gas from V_{3T}, with partial volume Vₐ which can be optimised | | |
| 14 | Check Valve; prevents backflow of Process Gas into the Compression Chamber | | |
| 15 | Air Vessel; pressure-charging with gas from V_{3T} (to close to p_{3T}) via check valve | | |
| 16 | Supply Line for gas for the Pore-Stream to the PW (possibly via P-Pump) | | |
| 17 | Channel Space space of the channels in the PW for Pore-Stream supply in PW | | |
| 18 | A-Stream Line to the K-Flux into the PK; if applicable; Valve-Stream (with poss. A-Stream) | | |
| 19 | HD-Line behind the D-Pump; draws in gas from the crankcase | | |
| 20 | Intake Port for supply of intake air in P₅₁; advantageously from turbo charger | | |
| 21 | Exhaust Port for expulsion of exhaust gas in P₅₁; potentially to drive the turbo | | |
| 22 | Crosspieces between the vertical component-ports (slits) for intake air/exhaust gas | | |
| 23 | Springing of the valve-stem; for instance disc- or slit- or spiral-spring | | |
| 24 | Head Wall KW Pore Wall in valve-head for Valve-Stream to the PK | | |
| 25 | Thermocouple-Gap-Tube from the blocking oscillator (startup-ignition, control) | | |
| 26 | Throttle flux-throttle or stream-throttle (T_{K}-/p_{K}-control) | | |
| 27 | Process-Pump (P-Pump), delivers PC-Gas up to a pressure > p_{K} (gear pump) | | |
| 28 | Fuel-Pump for K-Flux into the PK (possibly with throttle as a flux-throttle) | | |
| 29 | Dose-Pump (D-Pump) | \| | 30 Flux-Pump (F-Pump) |
| 31 | Lubricant Entry-Pump | \| | 32 Lubricant Circulation-Pump |

| 33 | Entry-Line and Entry-Point for lubricant to the ZW-inner-surface | |
|---|---|---|
| 34 | Circulation-Line and Circulation-Point for lubricant from the crankcase | |
| 35 | VZ Valve-Cylinder | cylinder sliding in the DW as part of the Cylinder-Valve |
| 36 | AZ Upper-Cylinder | sits atop the VZ with well reduced cross-sectional area |
| 37 | Blowholes A-Stream - through the AZ into the VZ - blows K-Flux into the PK | |
| 38 | Valve-Cone-Seal opens and closes the passage for Transit-Stream PK/BR | |
| 39 | RR Ring-Space | enclosed by DW above the VZ/AZ-constriction |

| | |
|---|---|
| 40 | Vent for streaming-out from RR followed by streaming-in of gas with p_{A} > p_{K}. |

1-10. (canceled)

11. A heat engine comprising:
a process chamber being arranged for sustaining a high pressure at a high temperature and for processing fuel into a combustible material;
a combustion chamber into which in use combustible material enters from the process chamber for combustion;
a valve for streaming of the combustible material from the process chamber into the combustion chamber for combustion therein; and
at least one feedline for supply of a fuel into the process chamber for processing to a combustible material therein,
wherein the process chamber has an interior that is sufficiently large to hold combustible material for more than one cycle.

12. The heat engine of claim 11 wherein the fuel is a fluid.

13. The heat engine of claim 11 wherein the combustion chamber is separated from the process chamber by a separating wall.

14. The heat engine of claim 11 wherein the combustible material comprises at least one of gas, smoke, soot and fuel residuals.

15. The heat engine of claim 11 wherein a heat wall surrounds at least a portion of the processing interior of the process chamber, the heat wall comprising pathways for gases into the interior of the process chamber.

16. The heat engine of claim 15 wherein the heat wall encloses the interior of the process chamber.

17. The heat engine of claim 15 wherein the heat wall is at least partially enclosed by a pressure wall.

18. The heat engine of claim 15 wherein the heat wall is gas-permeable with pores as a pathway for gases into the interior of the process chamber.

19. The heat engine of claim 11 comprising at least one piston and being arranged so that combustible material from the process chamber enters a space above the piston for combustion.

20. The heat engine of claim 13 wherein the separating wall is impermeable and compact and the valve provides a seal therein.

21. The heat engine of claim 19 wherein the valve can be opened in a culmination zone of the piston for streaming of combustible material from the process chamber into the combustion chamber for combustion therein.

22. The heat engine of claim 17 wherein the valve comprises a hollow cylinder sliding within a sliding seat in the pressure wall,
and the hollow cylinder terminates below with a valve-cone providing a seal in the separating wall, and
the sliding seat ends shortly above a cone-shoulder and is covered by the heat wall towards the process chamber.

23. The heat engine of claim 11 comprising a gear pump for pumping the fuel into the process chamber.

24. The heat engine of claim 11 comprising a fuel pump that is arranged to pump the fuel into the process chamber,
and wherein the fuel pump is a two-piece pump: a dose-pump arranged to determine a fuel-dose
and a flux-pump arranged to pump against a pressure gradient with multiple times the delivery-rate of the dose-pump,
and wherein a line introduces low-pressure gas behind the dose-pump.

25. The heat engine of claim 11 comprising a process-pump arranged to deliver the fuel-processing gas up to a pressure greater than the process-chamber-pressure and to push this gas into the process chamber.

26. The heat engine of claim 25 wherein the process pump is arranged to push the gas into the process chamber as at least one of wall-stream through the heat wall around the process chamber and adding-stream added to the fuel-flux through a supply line behind the fuel pump.

27. The heat engine of claim 11 comprising a bulb consisting of a thermocouple directed into the process chamber,
the bulb being arranged so that via a magnetic core of a blocking oscillator that is driven into saturation by a thermo-current,
at least one of ignition at engine start-up, ignition on demand and temperature regulation is provided.

28. A heat engine with at least one piston,
in which in the culmination zone combustible material from a pre-chamber enters the space above the piston through a valve for combustion in the intake air compressed by the piston,
wherein, separated from the compression chamber PR by an impermeable and compact separating wall TW with a valve Ve providing a seal therein,
a process chamber PK is arranged, into which fluid fuel is pushed over a long period (for instance continually) with at least one feedline,
and in which this fuel is processed in the PK-Gas already contained in the PK to a combustible material (gas, possibly with smoke+soot),
and in which this combustible material is at sustained high pressure and process-temperature, and
additionally the PK contains an amount of processed combustible material sufficient for at least two engine cycles, and
the valve is opened in the culmination zone of the piston and as a result,
combustible material from the process chamber PK streams into the compression chamber for combustion therein, and
wherein, a heat wall WW encloses the processing interior of the process chamber and this heat wall is enclosed on its sides and above by a compact pressure wall DW and that this heat wall WW is gas-permeable with pores as pathways for oxygen-overstoichiometric, processing gas into the processing interior of the process chamber.

29. A heat engine with at least one piston, in which in the culmination zone combustible
material from a prechamber enters the space above the piston through at least one opening,
for combustion in the intake air compressed by the piston,
wherein, separated from the compression chamber PR by an impermeable, compact separating wall TW with a valve Ve providing a seal therein,
a process chamber PK is arranged, which in its interior sustains high pressure at high temperature, for processing fluid fuel into a combustible material, that can consist of gas and possibly smoke, soot and fuel residuals,
and that at least one feedline is connected, for preferably slow supply of fluid fuel into the process chamber PK for processing to a combustible material therein,
and that the interior of the process chamber PK is sufficiently large to hold combustible material for at least two cycles, and that the valve can be opened in the culmination zone of the piston,
for streaming of combustible material from the process chamber PK into the compression chamber PR for combustion therein, and
wherein a heat wall WW encloses the processing interior of the process chamber and this heat wall is enclosed on its sides and above by a compact pressure wall DW and that this heat wall WW is gas-permeable with pores as a pathway for gases of any origin into the interior of the process chamber.

30. A method of operating a heat engine, the method comprising:
pushing of overstoichiometric gas into a process chamber;
reacting the overstoichiometric gas with understoichiometric process chamber gas resulting in a hot, understoichiometric process chamber gas;
directing the resultant hot, understoichiometric process chamber gas into a combustion chamber for combustion with a suitable supply gas;
wherein the method is conducted so that the process chamber contains an amount of the resultant hot, understoichiometric process chamber gas that is sufficient for more than one cycle of the heat engine.

31. The method of claim 30 wherein at least one of the process chamber gas and the supply gas have a temperature above autoignition temperature.
